(19) United States
(12) Patent Application Publication
(10) Pub. No.: US 2014/0040237 A1
(43) Pub. Date: Feb. 6, 2014

(54) DATABASE RETRIEVAL IN ELASTIC STREAMING ANALYTICS PLATFORM

(71) Applicants: Qiming Chen, Cupertino, CA (US); Meichun Hsu, Los Altos Hills, CA (US)

(72) Inventors: Qiming Chen, Cupertino, CA (US); Meichun Hsu, Los Altos Hills, CA (US)

(21) Appl. No.: 13/563,176

(22) Filed: Jul. 31, 2012

(51) Int. Cl. G06F 17/30

(52) U.S. Cl. 707/722; 707/770; 707/E17.014; 707/E17.032

(57) ABSTRACT

Managing retrieval of data from a data streaming process, such that a query required by multiple operator instances is not executed more than once. A Data Access Station (DAS) facilitates data retrieval for an operator(s) O and its multiple operator instances, and mitigates (or avoids) repetition of queries by the multiple operator instances.

### CROSS-REFERENCE TO RELATED APPLICATIONS

This application is related to U.S. patent application of inventors: Qiming Chen and Meichun Hsu, which is assigned Ser. No. ______ filed concurrently and entitled “OPEN STATION CANONICAL OPERATOR FOR DATA STREAM PROCESSING”. The entirety of the above-referenced applications is incorporated herein by reference.

### BACKGROUND

Large-scale computational infrastructures have become prevalent in implementing large, real-world continuous streaming data. Today, business intelligence systems have come to rely on these infrastructures as tools for capturing and analyzing generated data in real time. Such data analytics platforms are receiving significant attention from the business world, and their efficient operation is becoming of paramount importance.

### BRIEF DESCRIPTION OF THE DRAWINGS

FIG. 1 illustrates an example for an implementation of a Data Access Station (DAS), in accordance with the subject disclosure.

FIG. 2 illustrates another example for an implementation of the single database connection in data flow processing for an extended Linear-Road benchmark, according to the subject disclosure.

FIG. 3 illustrates a related aspect for data-parallel execution of operators, according to another implementation of the subject disclosure.

FIG. 4 illustrates an example of a methodology for employing a Data Access Station according to the subject disclosure.

FIG. 5 illustrates a related methodology of executing queries by the Data Access Station in accordance with an implementation of the subject disclosure.

FIG. 6 illustrates an inference component that interacts with the DAS to facilitate retrieval of results in response to queries.

FIG. 7 provides a schematic diagram of an exemplary networked or distributed computing environment, in which examples described herein can be implemented.

### DETAILED DESCRIPTION

Dataflow processes may be modeled as a graph-structured topology, wherein a logical operator can process input data tuple by tuple or chunk by chunk. The logical operator may further be executed by a number of operator instances in parallel elastically, wherein input data touted to such instance operators are partitioned. To this end, retrieving data can be established by a connection to an underlying database (e.g., Open Database Connectivity, Java-based data access technology).

However in such retrieval and analysis systems, various challenges are paramount. For example, when a logical operator is executed by a large number of operator instances (e.g., 100) establishing many database connections and query instances remains unfeasible. Moreover, when the query is an insert query to persist partial results of stream analytics, various difficulties in concurrency control may occur. Overcoming such complexities, one implementation of the subject disclosure employs a single connection for a single query.

Another issue with multiple individual database connections and query instances, pertains to cache requirements for multiple copies of query results, which can burden available resources. Also, running a logical operator by multiple instances, may require partitioning input data to these multiple instances. Even though, each operator instance may require only a partition of the database retrieval results—nonetheless, such requirement remains unfeasible when providing queries with different filter conditions for those operator instances. Moreover, because the database retrieval process itself inherently remains on-demand (e.g. in the beginning or in processing each chunk), it cannot be treated as a continuous stream source.

Various aspects of the subject disclosure provide for platforms and processes that manage database retrieval in continuous, parallel, distributed, and at the same time elastic streaming analytics—via supplying a dedicated station (referred to as a Data Access Station, DAS in the subject disclosure). Such DAS facilitates database retrieval of an operator(s) O, and can run continuously to maintain a designated database connection/prepared queries, yet it executes the queries only on-demand (e.g., the DAS does not serve as a continuous data source of the dataflow process), and ensures a query that requires repetition by the multiple instances is executed only once, and not more—hence preserving system resources.

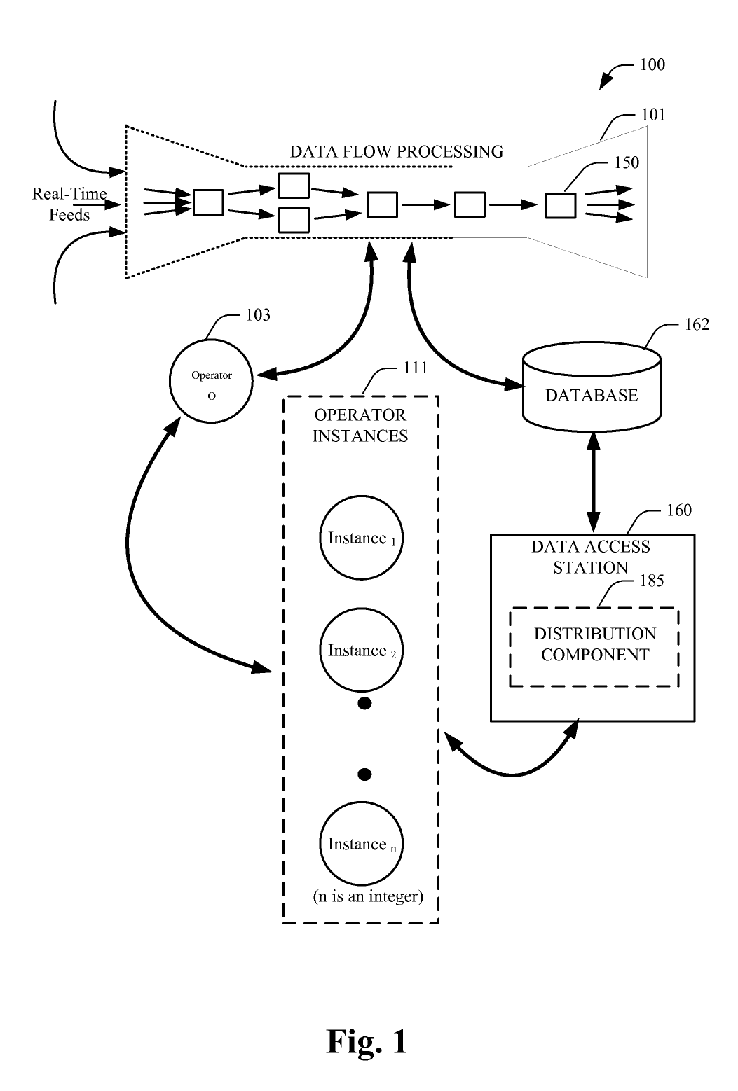

FIG. 1 illustrates an implementation example for a Data Access Station 160, which is associated with a stream analytics platform 100 being substantially parallel, distributed and elastic. In the stream analytics platform 100, a logical operator 103 can be executed by multiple physical operator instances 111, which run in data-parallel over distributed server nodes. The operator 103 can store/retrieve data from database(s) 162, wherein upon deploying a logical stream topology, multiple instances 111 of the operator can be launched. Subsequently, if the operator 103 is designed with database access, each of its instances may also need to access the database (e.g., for running an identical query, and/or a query wherein all or parts of it needs to be repeated by the multiple instances; and/or for processing identical information or request for data that are shared among some or all the multiple instances, and the like.)

Various implementations of the subject disclosure mitigate problems (in both the database client & server side), which may arise from numerous database accesses by multiple operator instances in a database connection. To this end, the DAS 160 of the subject disclosure can enhance scalability without losing control of database connections—while ensuring efficiency and without causing jam on the database engine side. The DAS 160 can further ensure consistency of stream data partition in the dataflow graph. In addition, implementing the data access station 160 can further facilitate inserting into the database 162 buffered stream processing results, when so is required.

In one particular implementation, the DAS 160 can perform as an operator in the data flow processing process 101, wherein its functions include grouping the database retrieval results in a manner consistent with the stream data partitioning in the data flow processing 101. The data access station 160 can represent a dedicated station, which facilitates database retrieval of the operator(s) “O” 130. Running continuously, the DAS 160 can further maintain a designated database connection for query processing, and yet can execute such queries only on-demand. In this regard, the DAS generally does not serve as a continuous data source of the dataflow process.

In a related implementation, demands to access database 162 can arise from remote procedure calls (RPC) of {O1, O2, . . . , On}, wherein such RPC calls are for signaling that are idempotent (e.g., not for querying), while ensuring that each query is executed only once. The idempotent capabilities can facilitate that repeated invocations are safe and will not result in repeated querying.

For example, the query result for the current chunk-wise processing for O₁, O₂, . . . , Oₙ, can be buffered in the DAS 160 until the receipt of the last (Nth, where N is an integer) demand from an Oᵢ, which can sync the paces of O₁, O₂, . . . , Oₙ. Subsequently, query results can be shuffled to O₁, O₂, . . . , Oₙ by the distribution component 185, which can employ the same partition criterion as the input data to O₁, O₂, . . . , Oₙ, already known by the topology.

In the dataflow processing 160, a dataflow element, tuple, may either be originated from a data-source or derived by a logical operator, wherein the operator is stationed and continuous, and the logical operator can have multiple instances (threads) over multiple machine nodes. Moreover, streams from the instances of operator A to the instances of operator B can be grouped (e.g. partitioned) in a same way, as described in detail below.

For example, there can exist multiple logical operators, B₁, B₂, . . . , Bₙ, for receiving the output stream of A, but each with different data partition criterion. As such, and in context of framework for processing parallel problems across substantially large data set, a substantially flexible and elastic approach can hence be provided.

In a related implementation, the subject disclosure can facilitate safe parallelization in data stream processing. Typically, safe parallelization requires handling data flow in group-wise-fashion for each vertex that represents a logical operator in the dataflow graph. The operation parallelization with multiple instances occurs with input data partition (grouping), which remains consistent with the data buffering at each operation instance. Such further ensures processing a query exactly once by one of the execution instances of O, in presence of multiple execution instances of an operator, O.

Furthermore, historical data processing states of every group of partitioned data can be buffered with one and only one execution instance of O. Accordingly, the analytics platform of the subject disclosure can be characterized as “real-time” and “continuous”, with the capability of parallel and distributed computation on real-time and infinite streams of messages, events and signals.

By employing the DAS of the subject disclosure, various advantages are obtained wherein: scalability can be further enhanced without losing control to database connections; efficiency can be improved without causing jam on the database engine side; and consistency of stream data partition further insured in the dataflow graph. In addition, the dedicated database access station of the subject disclosure further enables buffering the stream processing results and their insertions into the database—hence mitigating the database synchronizations becoming a road block for real-time stream processing.

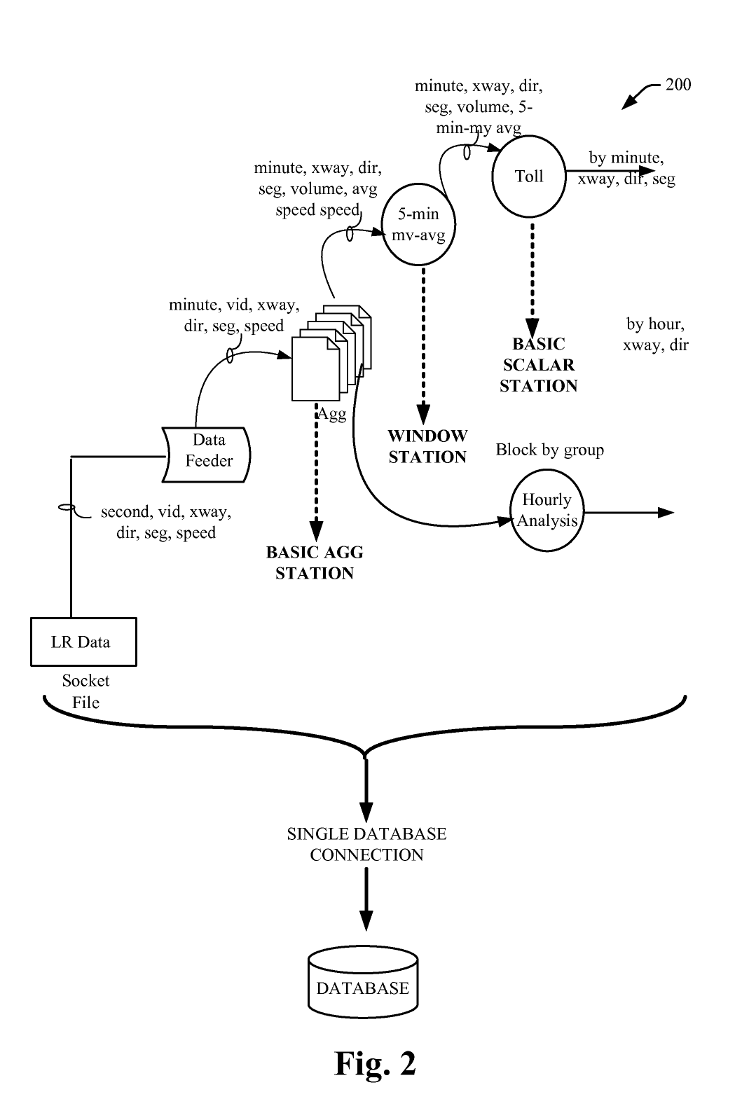

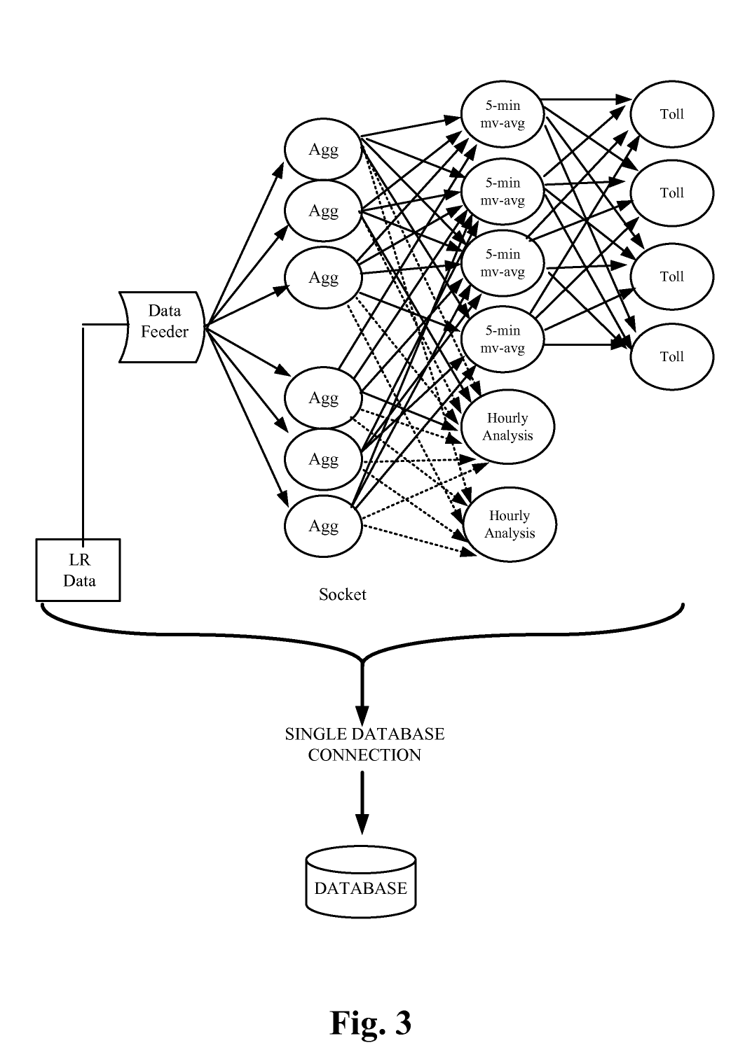

FIG. 2 and FIG. 3 illustrate various implementations for the DAS of the subject disclosure in context of a specific example that employs a single database connection. As illustrated, a Linear-Road (LR) benchmark depicts traffic on 10 express ways, wherein each express way can have two directions and 100 segments, for example. To this end, vehicles may enter and exit any segment, and position of each car is read every 30 seconds—wherein each reading can constitute an event, or stream element, for the system.

For instance, a car position report has the attributes of: vehicle_id, time (in seconds), speed (mph), xway (express way), dir (direction), seg (segment), and the like. In a simplified benchmark, the traffic statistics for each highway segment, such as the number of active cars, their average speed per minute, and the past 5-minute moving average of vehicle speed, can be computed—wherein based on such per-minute per-segment statistics, the application computes the tolls to be charged to a vehicle entering a segment any time during the next minute. As an extension to the LR application, the traffic statuses can be analyzed and reported every hour.

In this regard, an exemplary stream analytics process can be specified using a computer language such as Java, as indicated by the computer code below;

```
  public class LR_Process {
  ...
  public static void main(String[ ] args) throws Exception {
```

ProcessBuilder builder = new ProcessBuilder( );
builder.setFeederStation(”feeder”, new

LR_Feeder(args[0]), 1);

builder.setStation(″agg″, new LR_AggStation(0, 1), 6)

.hashPartition(”feeder”,

new Fields(″xway″, ″dir″, ″seg″));

builder.setStation(″mv″, new LR_MvWindowStation(5),

4).hashPartition(″agg″,

new Fields(″xway″, ″dir″, ″seg″));

builder.setStation(″toll″, new LR_TollStation( ),

4).hashPartition(″mv″,

new Fields(″xway″, ″dir″, ″seg″));

builder.setStation(″hourly″, new LR_BlockStation(0, 7),

2).hashPartition(″agg″,

new Fields(″xway″, ″dir″));

Process process = builder.createProcess( );
Config conf = new Config( ); conf.setXXX(...); ...
Cluster cluster = new Cluster( );
cluster.launchProcess(″linear-road″, conf, process);
...

}

In the above topology specification, the hints for parallelization can be supplied to the operators “agg” (6 instances), “mv” (5 instances), “toll” (4 instances) and “hourly” (2 instances), the platform may make adjustment based on the resource availability.

As illustrated in FIG. 2 the operation “agg” aims to deliver the average speed in each express-way's segment per minute. Subsequently, an execution of this operation on an infinite stream can be performed in a sequence of epochs, one on each stream chunks, for example.

To enable applying such operation to the stream data one chunk at a time, and to return a sequence of chunk-wise aggregation results, the input stream can be divide into 1 minute (60 seconds) based chunks, S₀, S₁, . . . Sᵢ (where i is an integer), such that the execution semantics of “agg” is defined as a sequence of one-time aggregate operation on the data stream input minute by minute.

In general, given an operator, O, over an infinite stream of relation tuples S with a criterion “θ” for cutting S into an unbounded sequence of chunks, e.g. by every 1-minute time window, <S₀, S₁, . . . , Sᵢ, . . . > where Sᵢ denotes the i-th “chunk” of the stream according to the chunking-criterion θ. The semantics of applying O to the unbounded stream S lies in Q(S)→<Q(S₀), . . . Q(Sᵢ), . . . >

which continuously generates an unbounded sequence of results, one on each chunk of the stream data.

Punctuating input stream into chunks and applying operation epoch by epoch to process the stream data chunk by chunk can be considered as a type of meta-property of a class of stream operations, wherein it can be supported automatically and systematically by various aspects of the subject disclosure. In general, various implementations of the subject disclosure can host such operations on the epoch station (or the ones subclassing it) and provide system support.

An epoch station can host a stateful operation that is data-parallelizable, and therefore the input stream is hash-partitioned, which remains consistent with the buffering of data chunks as described earlier. Moreover, several types of stream punctuation criteria can be specified, such as punctuation by cardinality, by time-stamps and by system-time period, which are covered by the system function of:

public boolean nextChunk(Tuple, tuple) determining that the current tuple belongs to the next chunk or not.

If the current tuple belongs to the new chunk, the present data chunk is dumped from the chunk buffer for aggregation/group-by in terms of the user-implemented abstract method of

processChunkByGroup ( ).

Every input tuple (or derivation) can be buffered, either into the present or the new chunk. By specifying additional meta properties and by subclassing the epoch station, other instances can be introduced. For example, an aggregate of a chunk of stream data can be made once by end of the chunk, or tuple-wise incrementally. In the latter case an abstract method for per-tuple updating the partial aggregate can be provided and implemented by the user.

It is noted that the paces of dataflow with regards to timestamps can be different at different operators. For instance, the “agg” operator (and its downstream operators) can be applied to the input data minute by minute. Yet, when the “hourly analysis” operator is applied to the input stream minute by minute, it generates output stream elements hour by hour. As such, combination of group-wise and chunk-wise stream analytics provides a generalized abstraction for parallelizing and granulizing the continuous and incremental dataflow analytics. An example for the physical instances of these operators for data-parallel execution as described above is illustrated in FIG. 3, which employs a single database connection for data retrieval.

In such analytics platform, the dedicated Data Access Station (DAS) ensures that each query is issued only once—even though a logical operator is executed many times by various operator instances—hence avoiding concurrency problems that can over crowd the system. The DAS executes queries on demand based on remote procedure calls—(as opposed to serving as a continuous data source in the dataflow process), and distributes the results among all instances of the operator, based on partition criteria that is already available in the analytics platform, for the various operator instances.

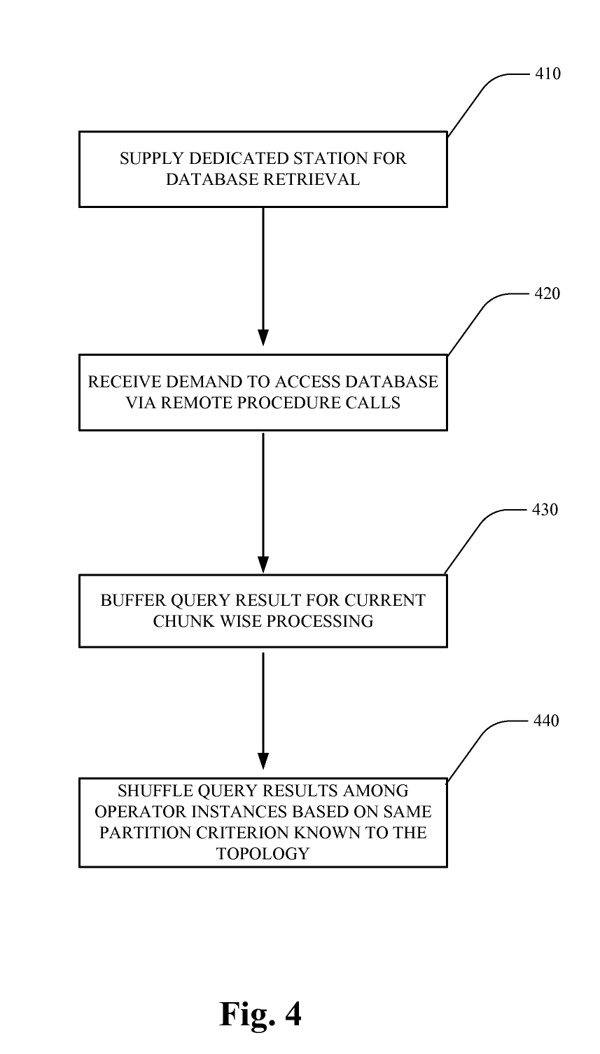

FIG. 4 illustrates a related methodology 400 for employing a DAS according to a further aspect of the subject disclosure. While this exemplary method is illustrated and described herein as a series of blocks representative of various events and/or acts, the subject innovation is not limited by the illustrated ordering of such blocks. For instance, some acts or events may occur in different orders and/or concurrently with other acts or events, apart from the ordering illustrated herein, in accordance with the invention. In addition, not all illustrated blocks, events or acts, may be required to implement a methodology in accordance with the subject innovation. Moreover, it will be appreciated that the exemplary method and other methods according to the innovation may be implemented in association with the method illustrated and described herein, as well as in association with other systems and apparatus not illustrated or described.

Initially and at 410, a dedicated station (DAS) is supplied, which can facilitate database retrieval of one or more operators O. Such DAS facilitates database retrieval of an operator(s) O, and can run continuously to maintain a designated database connection—and yet executes the queries only on-demand (e.g., the DAS does not serve as a continuous data source of the dataflow process.)

At 420 demand for accessing the database can be received via remote procedure calls (RPC) of {O1, O2, . . . , On}, wherein such RPC calls are for signaling that are idempotent (e.g., not for querying), and while ensuring that each query is executed only once. Moreover, such idempotent capabilities can further ensure that repeated invocations are safe and will not result in repeated querying. Next and at 430, the query result for a current chunk-wise processing in O₁, O₂, . . . , Oₙ, can be buffered in the DAS until the receipt of the last (Nth) demand from an Oᵢ, which sync the paces of O₁, O₂, . . . , Oₙ. Such query results can then be shuffled at 440, to O₁, O₂, . . . , Oₙ. by the same partition criterion as the input data to O₁, O₂, . . . , Oₙ, which is known to the topology.

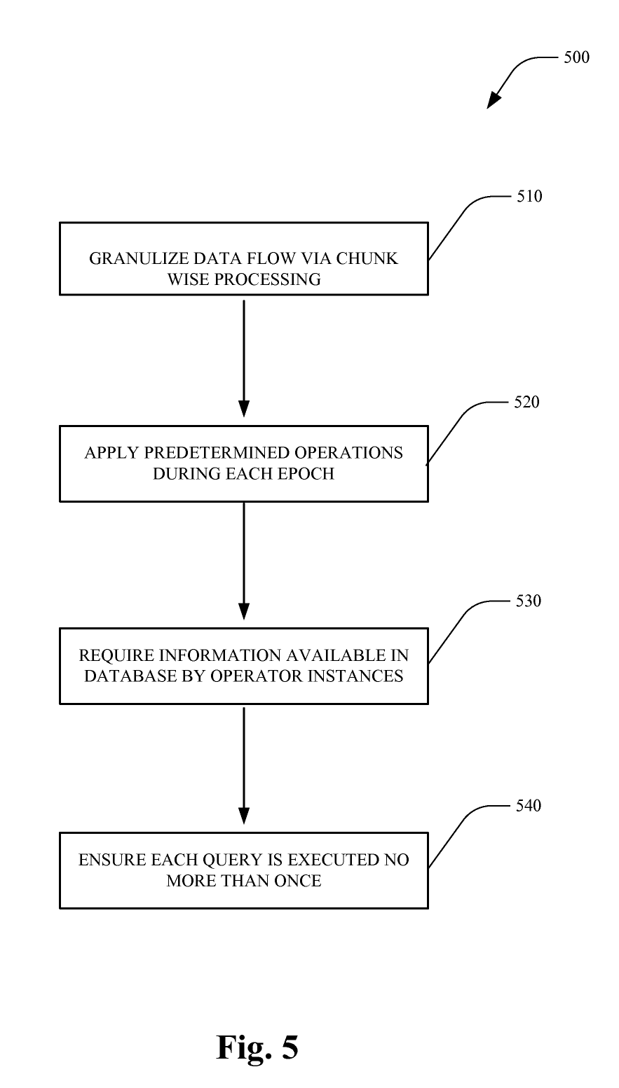

FIG. 5 illustrates a related methodology 500 according to a further aspect of the subject disclosure. Initially and at 510 data flow can be granulized via chunk wise processing—wherein performing granule semantics and managing dataflow in the data streaming process can occur in a “chunk-wise” manner, by punctuating and buffering data consistently. Subsequently and at 520, tuples associated with a chunk can be processed, wherein predetermined operations (e.g., aggregations) can be applied to the data chunk-wise and at end of each epoch, while other operations may be deemed tuple-wise. At 530 a logical operator that is executed by a substantially large number of operator instances in parallel and elastically, may require retrieval of data from a database. Typically, if an operator is designed with database access, each of its instances may also need to access the database. Subsequently and at 540, queries associated with such information retrieval can be executed no more than once, and on-demand (e.g., the DAS does not serve as a continuous data source of the dataflow process).

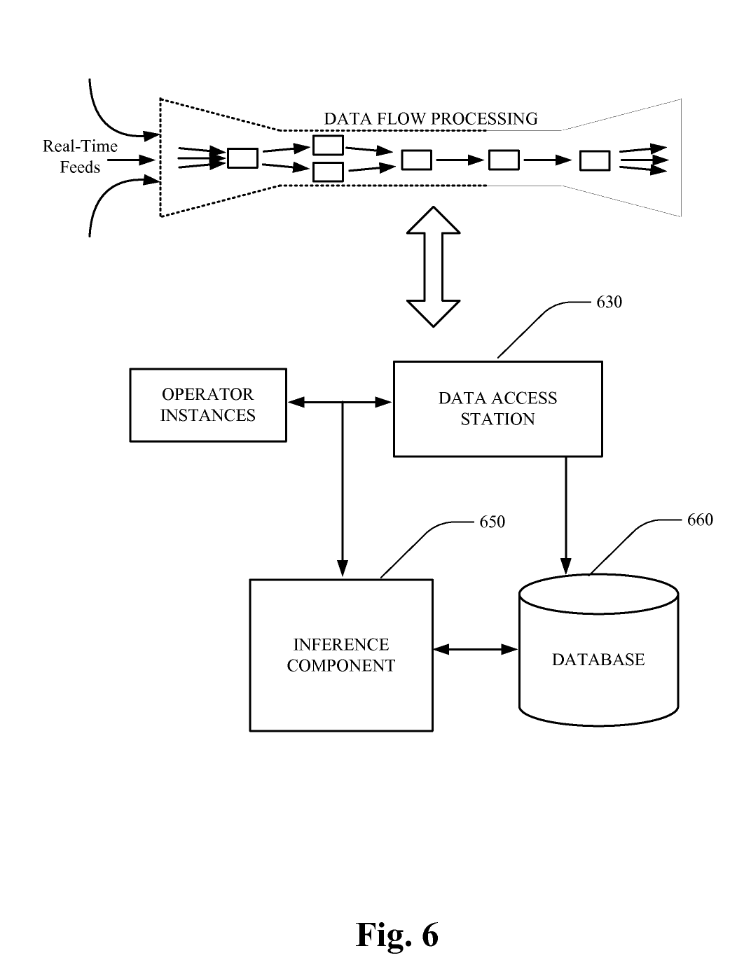

FIG. 6 illustrates an inference component (e.g., an artificial intelligence) 650 that can interact with the DAS 630, to facilitate inferring and/or determining when, where, how to access the database 660 for responding/fulfilling information requests associated with operator instances, according to an aspect of the subject disclosure.

As used herein, the term “inference” refers generally to the process of reasoning about or inferring states of the system, environment, and/or user from a set of observations as captured via events and/or data. Inference can identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

The inference component 650 can employ any of a variety of suitable AI-based schemes as described supra in connection with facilitating various aspects of the herein described subject matter. For example, a process for learning explicitly or implicitly how parameters are to be created for training models based on similarity evaluations can be facilitated via an automatic classification system and process. Classification can employ a probabilistic and/or statistical-based analysis (e.g., factoring into the analysis utilities and costs) to prognose or infer an action that a user desires to be automatically performed. For example, a support vector machine (SVM) classifier can be employed. Other classification approaches include Bayesian networks, decision trees, and probabilistic classification models providing different patterns of independence can be employed. Classification as used herein also is inclusive of statistical regression that is utilized to develop models of priority.

The subject application can employ classifiers that are explicitly trained (e.g., via a generic training data) as well as implicitly trained (e.g., via observing user behavior, receiving extrinsic information) so that the classifier is used to automatically determine according to a predetermined criteria which answer to return to a question. For example, SVM's can be configured via a learning or training phase within a classifier constructor and feature selection module. A classifier is a function that maps an input attribute vector, x=(x1, x2, x3, x4, xn), to a confidence that the input belongs to a class—that is, f(x)=confidence(class).

### Exemplary Networked and Distributed Environments

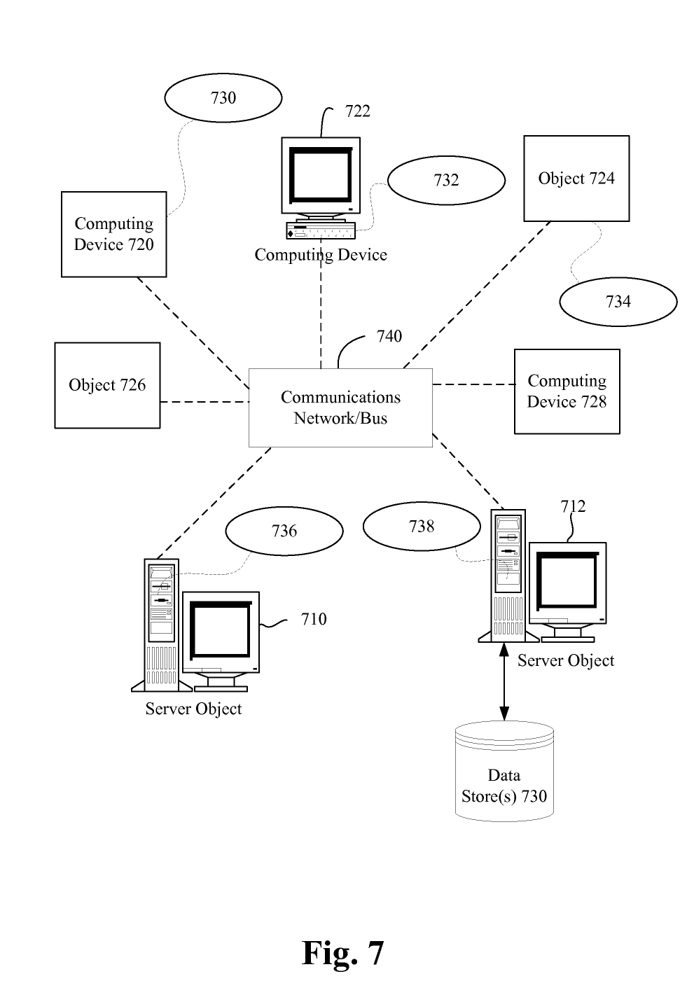

FIG. 7 provides a schematic diagram of an exemplary networked or distributed computing environment 700 in which examples described herein can be implemented. The distributed computing environment includes computing objects 710, 712, etc. and computing objects or devices 720, 722, 724, 726, 728, etc., which can include programs, methods, data stores, programmable logic, etc., as represented by applications 730, 732, 734, 736, 738. It is to be appreciated that computing objects 710, 712, etc. and computing objects or devices 720, 722, 724, 726, 728, etc. can include different devices, such as personal digital assistants (PDAs), audio/video devices, mobile phones, MPEG-1 Audio Layer 3 (MP3) players, personal computers, laptops, tablets, etc.

Each computing object 710, 712, etc. and computing objects or devices 720, 722, 724, 726, 728, etc. can communicate with one or more other computing objects 710, 712, etc. and computing objects or devices 720, 722, 724, 726, 728, etc. by way of the communications network 740, either directly or indirectly. Even though illustrated as a single element in FIG. 7, communications network 740 can include other computing objects and computing devices that provide services to the system of FIG. 7, and/or can represent multiple interconnected networks, which are not shown. Each computing object 710, 712, etc. or computing objects or devices 720, 722, 724, 726, 728, etc. can also contain an application, such as applications 730, 732, 734, 736, 738, that might make use of an application programming interface (API), or other object, software, firmware and/or hardware, suitable for communication with or implementation of the various examples of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems as described in various examples.

Thus, a host of network topologies and network infrastructures, such as client/server, peer-to-peer, or hybrid architectures, can be utilized. The client can be a member of a class or group that uses the services of another class or group. A client can be a computer process, e.g., roughly a set of instructions or tasks, that requests a service provided by another program or process. A client can utilize the requested service without having to know all working details about the other program or the service itself.

As used in this application, the terms “component,” “module,” “engine”, “system,” and the like are intended to refer to a computer-related entity (e.g., non-transitory), either hardware, software, firmware, a combination of hardware and software, software and/or software in execution. For example, a component can be, but is not limited to being, a process running on a processor, a processor, an object, an executable, a thread of execution, a program, and/or a computer. By way of illustration, both an application running on a computing device and/or the computing device can be a component. One or more components can reside within a process and/or thread of execution and a component can be localized on one computer and/or distributed between two or more computers. In addition, these components can execute from various computer-readable storage media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

In a client/server architecture, particularly a networked system, a client can be a computer that accesses shared network resources provided by another computer, e.g., a server. In the illustration of FIG. 7, as a non-limiting example, computing objects or devices 720, 722, 724, 726, 728, etc. can be thought of as clients and computing objects 710, 712, etc. can be thought of as servers where computing objects 710, 712, etc. provide data services, such as receiving data from client computing objects or devices 720, 722, 724, 726, 728, etc., storing of data, processing of data, transmitting data to client computing objects or devices 720, 722, 724, 726, 728, etc., although any computer can be considered a client, a server, or both, depending on the circumstances. Any of these computing devices can process data, or request transaction services or tasks that can implicate the techniques for systems as described herein for one or more examples.

A server can be typically a remote computer system accessible over a remote or local network, such as the Internet or wireless network infrastructures. The client process can be active in a first computer system, and the server process can be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network/bus 740 can be the Internet, for example, the computing objects 710, 712, etc. can be Web servers, file servers, media servers, etc. with which the client computing objects or devices 720, 722, 724, 726, 728, etc. communicate via any of a number of known protocols, such as the hypertext transfer protocol (HTTP). Computing objects 710, 712, etc. can also serve as client computing objects or devices 720, 722, 724, 726, 728, etc., as can be characteristic of a distributed computing environment.

As mentioned, the techniques described herein can be applied to any suitable device. It is to be understood, therefore, that handheld, portable and other computing devices and computing objects of all kinds are contemplated for use in connection with the various examples. In addition to the various examples described herein, it is to be understood that other similar examples can be used or modifications and additions can be made to the described example(s) for performing the same or equivalent function of the corresponding example(s) without deviating there from. Still further, multiple processing chips or multiple devices can share the performance of one or more functions described herein, and similarly, storage can be affected across a plurality of devices. The subject disclosure is not to be limited to any single example, but rather can be construed in breadth, spirit and scope in accordance with the appended claims.

What is claimed is:

1. A system for retrieval of data from a data streaming process, comprising:
an operator that runs as multiple instances in the data streaming process;
a Data Access Station that executes a query exactly once, wherein the query retrieves same information that is required by the multiple instances;
a distribution component that distributes a result of the query, among the multiple instances in the data streaming process.

2. The system of claim 1, wherein the query arises from a Remote Procedure Call (RPC) that is employed for signaling.

3. The system of claim 1, wherein the Data Access Station is as an operator in the data streaming process.

4. The analytics system of claim 1, wherein the operator receives data as partitions.

5. The analytics system of claim 1 further comprising an inference component that infers database access in response to information requests by the multiple instances.

6. A method of retrieving data in a data streaming process comprising:
running an operator of the data streaming process as multiple instances;
executing only once a query that retrieves same information required by the multiple instances; and
distributing a result of the query, among the multiple instances based on a partition criteria for the multiple instances.

7. The method of claim 6 further comprising granulizing the data stream by chunk-wise processing, into stream chunks.

8. The method of claim 7 further comprising partitioning data, based on the multiple instances of the operator.

9. The method of claim 8 further comprising grouping database retrieval results consistent with the partitioning.

10. The method of claim 9 further comprising buffering states of processed data based on execution instance of the operator.

11. The method of claim 10 further comprising parallelizing execution for multiple instances of the operator.

12. The method of claim 11 further comprising applying a predetermined operator at an end of an epoch that is associated with a stream chunk.

13. The method of claim 12 further comprising inferring information required by the multiple instances via an artificial intelligence.

14. A computer system comprising:
a storage medium that stores computer-executable instructions,
a processor communicatively coupled with the storage medium, to facilitate execution of the computer-executable instructions to at least:
execute an operator of a data stream to create a plurality of operator instances;
retrieve no more than once a result for a query that is required by the multiple instances; and
distribute the result among the multiple instances based on partition criteria for the plurality of operator instances.

15. The computer system of claim 14, wherein the processor further facilitates execution of the computer-executable instructions to parallelizing execution for multiple instances of the operator.
